(19) United States
(12) Patent Application Publication
(10) Pub. No.: US 2005/0010576 A1
(43) Pub. Date: Jan. 13, 2005

(54) File differencing and updating engines

(76) Inventors: Liwei Ren, Alviso, CA (US); Jinsheng Gu, Alviso, CA (US); David Lai, Fremont, CA (US)

Correspondence Address: Shemwell Gregory & Courtney LLP, Suite 201, 4880 Stevens Creek Boulevard, San Jose, CA, 95129, US

(21) Appl. No.: 10/616,615

(22) Filed: Jul. 9, 2003

(51) Int. Cl. G06F 17/00

(52) U.S. Cl. 707/100

(57) ABSTRACT

A file differencing and updating system is provided that includes a file differencing component and a file updating component. The file differencing component, or file differencing engine, generates a difference file in a first processor-based or computer system from an original or old version and a new version of an electronic file. The file updating component, or file updating engine, generates a copy of the new file on a second processor-based or computer system using the difference file and the hosted copy of the original file.

### RELATED APPLICATION

This application relates to U.S. patent application Ser. No. 10/146,545, filed May 13, 2002 and U.S. patent application No. (not yet assigned; application titled PROCESSING SOFTWARE IMAGES FOR USE IN GENERATING DIFFERENCE FILES, Attorney Docket Number DOGO.P011), filed Jun. 20, 2003.

### TECHNICAL FIELD

The disclosed embodiments relate to updating of electronic files using difference files.

### BACKGROUND

Software running on a processor, microprocessor, and/or processing unit to provide certain functionality often changes over time. The changes can result from the need to correct bugs, or errors, in the software files, adapt to evolving technologies, or add new features, to name a few. In particular, embedded software components hosted on mobile processing devices, for example mobile wireless devices, often include numerous software bugs that require correction. Software includes one or more files in the form of human-readable American Standard Code for Information Interchange (ASCII) plain text files or binary code. Software files can be divided into smaller units that are often referred to as modules or components.

Portable processor-based devices like mobile processing devices typically include a real-time operating system (RTOS) in which all software components of the device are linked as a single large file. Further, no file system support is typically provided in these mobile wireless devices. In addition, the single large file needs to be preloaded, or embedded, into the device using a slow communication link like a radio, infrared, or serial link.

Obstacles to updating the large files of mobile processing devices via slow communication links include the time, bandwidth, and cost associated with delivering the updated file to the device. One existing solution to the problem of delivering large files to mobile processing devices includes the use of compression. While a number of existing compression algorithms are commonly used, often, however, even the compressed file is too large for download to a device via a slow, costly, narrowband communication link.

Another typical solution for updating files uses difference programs to generate a description of how a revised file differs from an original file. There are available difference programs that produce such difference data. However, as with compression, the difference files produced using these difference programs can sometimes be too large for efficient transfer via the associated communication protocols.

### BRIEF DESCRIPTION OF THE FIGURES

FIG. 1 is a block diagram showing a file differencing and updating system, under an embodiment.

FIG. 2 is a block diagram of a file differencing engine, under the embodiment of FIG. 1.

FIG. 3 is a block diagram of a file updating engine, under the embodiment of FIG. 1.

FIG. 4 is a flow diagram for generation of a delta file, under the embodiment of FIG. 1 and FIG. 2.

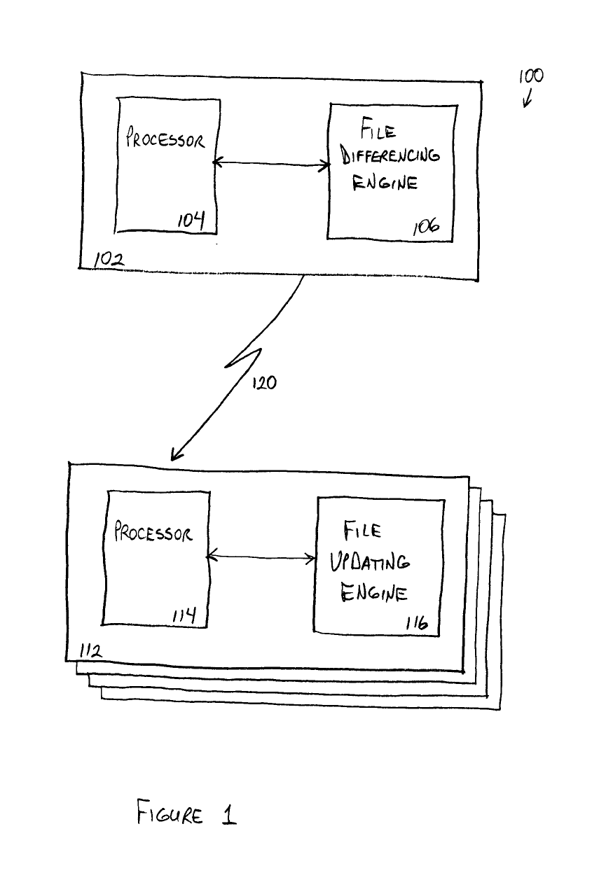

In the drawings, the same reference numbers identify identical or substantially similar elements or acts. To easily identify the discussion of any particular element or act, the most significant digit or digits in a reference number refer to the Figure number in which that element is first introduced (e.g., element 106 is first introduced and discussed with respect to FIG. 1).

### DETAILED DESCRIPTION

Systems and methods for generating difference files between two versions of an electronic file, herein referred to as file differencing, are described in detail herein. Further, systems and methods for updating original versions of electronic files using difference files, herein referred to as file updating, are described in detail herein. FIG. 1 is a block diagram showing a file differencing and updating system 100, under an embodiment. Generally, the file differencing and updating system includes a file differencing component and a file updating component. The differencing component, referred to herein as the file differencing engine, or differencing engine, generates a difference file in a first processor-based or computer system from an original or old version and a new version of an electronic file. The updating component, referred to herein as the file updating engine, or updating engine, generates a copy of the new file on a second processor-based or computer system using the difference file and the hosted copy of the original file.

In the following description, numerous specific details are introduced to provide a thorough understanding of, and enabling description for, embodiments of the invention. One skilled in the relevant art, however, will recognize that the invention can be practiced without one or more of the specific details, or with other components, systems, etc. In other instances, well-known structures or operations are not shown, or are not described in detail, to avoid obscuring aspects of the invention.

With reference to FIG. 1, a first computer system 102 and a second computer system 112 communicate via a communication path 120. These computer systems 102 and 112 include any collection of computing components and devices operating together, as is known in the art. The computer systems 102 and 112 can also be components or subsystems within a larger computer system or network.

The first computer system includes at least one processor 104 coupled to at least one file differencing engine 106, described in detail below. The processor 104 and file differencing engine 106 can also be coupled among any number of components (not shown) known in the art, for example buses, controllers, memory devices, and data input/output (I/O) devices, in any number of combinations.

The second computer system includes at least one processor 114 coupled to at least one file updating engine 116, described in detail below. The processor 114 and file updating engine 116 can also be coupled among any number of components (not shown) known in the art, for example buses, controllers, memory devices, and data input/output (I/O) devices, in any number of combinations. The file differencing engine 106 and the file updating engine 116 form the file differencing and updating system 100.

The communication path 120 includes any medium by which files are communicated or transferred between the computer systems 102 and 112. Therefore, this path 120 includes wireless connections, wired connections, and hybrid wireless/wired connections. The communication path 120 also includes couplings or connections to networks including local area networks (LANs), metropolitan area networks (MANs), wide area networks (WANs), proprietary networks, interoffice or backend networks, and the Internet. Furthermore, the communication path 120 includes removable fixed mediums like floppy disks, hard disk drives, and CD-ROM disks, as well as telephone lines, buses, and electronic mail messages.

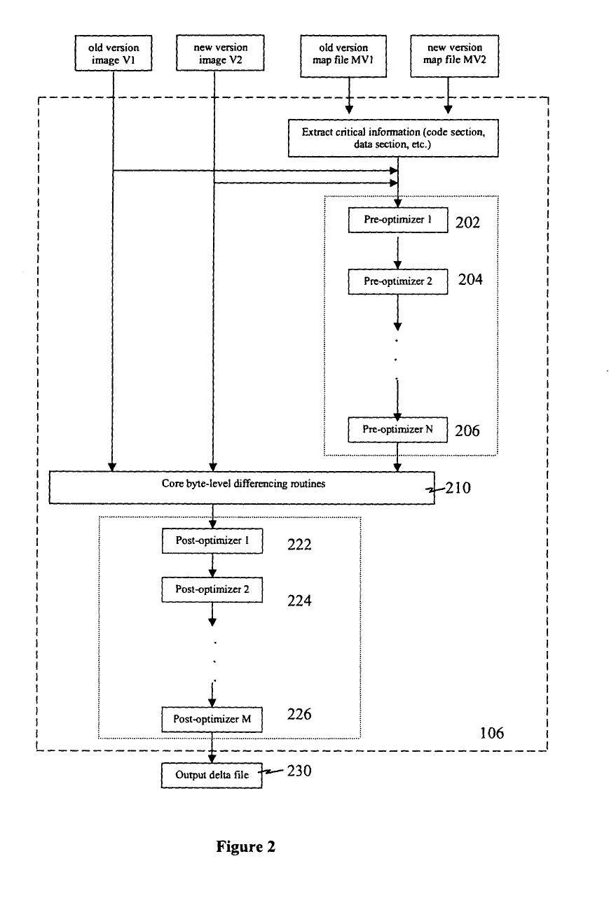

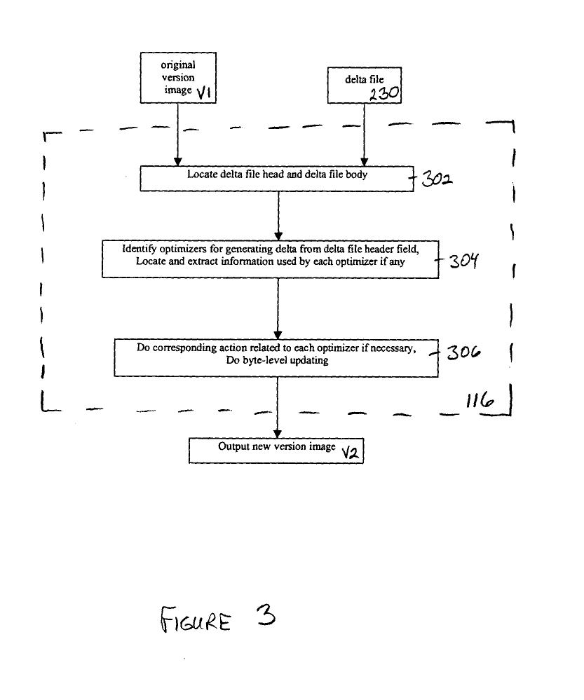

FIG. 2 is a block diagram of a file differencing engine 106, under the embodiment of FIG. 1. FIG. 3 is a block diagram of a file updating engine 116, under the embodiment of FIG. 1. Generally, and with reference to FIGS. 1, 2, and 3, the first communication system 102 receives an original, or old, version V1 and a new version V2 of an electronic file. The new version V2 is generally an updated or revised version of the original version V1, but is not so limited. The electronic files 110 and 112 include software files including dynamic link library files, shared object files, embedded software components (EBSCs), firmware files, executable files, data files including hex data files, system configuration files, and files including personal use data, but are not so limited. The map files MV1 and MV2 corresponding to the original V1 and the new V2 versions are also received. The map file is a high-level text file that includes the start address and size of each symbol of a software image, with symbol examples including function and global variables. The map file is output by compiler/linker utilities, and is also known as a log file, symbol file, and/or list file.

Components of the file differencing engine 106 receive the new version V2, compare it to the original version V1, and calculate the differences between the compared files, as described below. These differences include byte-level differences between the compared files, but are not so limited. The file differencing engine 106 of an embodiment generates and outputs a difference file 230, also referred to as a delta file 230, during the comparison.

The components of the file differencing engine 106 of an embodiment include at least one pre-optimizer system 202-206, at least one differencing system 210, and at least one post-optimizer system 222-226. The pre-optimizer systems 202-206, differencing systems 210, and post-optimizer systems 222-226 include at least one processor running under control of at least one pre-optimizer, differencing, and post-optimizer algorithm, program, or routine, respectively.

Contents of the delta file 230 provide an efficient representation of the differences between the new version V2 and the original version V1. The delta file 230 includes meta-data along with actual data of replacement and/or insertion operations that represent the differences between the new or current version of the associated file and previous versions of the file, as described in the Related Applications, but is not so limited.

The delta file 230 is transferred or transmitted to the second computer system 112 via the communication path 120. The updating engine 116 hosted on the second computer system 112 uses the delta file 230 along with the hosted original version V1 to generate or create a copy of the new version V2. This copy of the new version V2 is then used to update the original file hosted on the second computer system 112 that is targeted for revision or updating.

The differences between an original file and a new file are typically smaller than the new file, leading to significant storage and transmission savings if the differences are transmitted and stored instead of the entire new file. This is particularly important for mobile electronic devices (client devices) hosting programs that are updated via connections that typically can be slow and expensive, for example wireless or cellular connections. The reduced size of the delta file provides numerous improvements, one of which includes a reduction in bandwidth required for transmission of the delta file to the client device; the smaller file means less bandwidth is required for the transfer. Also, smaller files require less time for transmission and, therefore, decrease the probability that the file transfer will be interrupted and simultaneously reduce transmission errors in the received file. In addition, it is safer to transmit the delta files than the new software images via a non-secure connection. All of these improvements increase customer satisfaction.

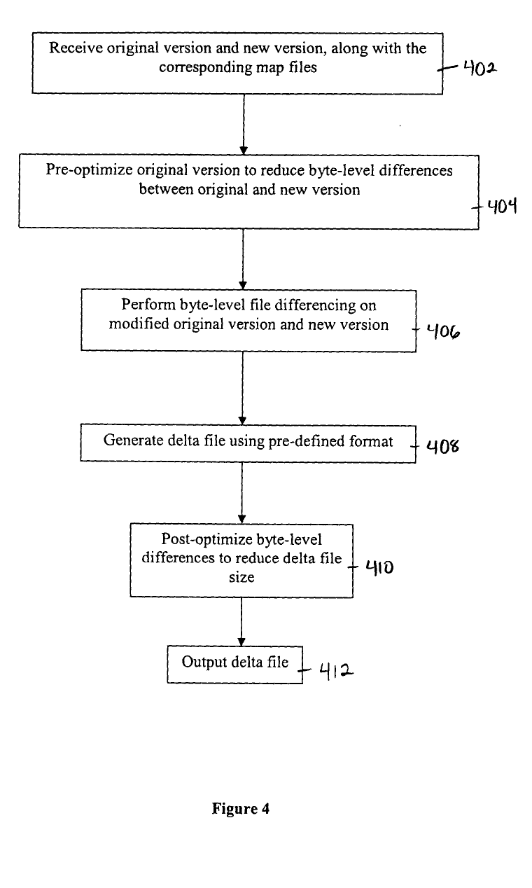

FIG. 4 is a flow diagram for generation of a delta file, under the embodiment of FIG. 1 and FIG. 2. With further reference to FIG. 2, operation begins when a new file and an original file are received in a first computer system, at block 402. The map files corresponding to the new and original files are also received, and information is extracted from the map files. Pre-optimizing operations are performed on the original version in order to reduce differences between the original and new versions, for example byte-level differences, at block 404. Generally, the pre-optimizing uses identified common segments and patterns to reduce/remove pre-specified changes between the new and original files, as described below. Thus, this pre-optimizing reduces the differences among common segments of the files, thereby increasing the efficiency of the difference calculation.

Following pre-optimizing, the byte-level differences are calculated between the new version and the modified original version, at block 406. The calculated differences are coded and merged, and the delta file is generated by following the pre-defined encoding format, at block 408. The delta file is then post-optimized to further reduce the file size, at block 410. The delta file is provided as an output, at block 412.

As described above, pre-optimizing operations are performed between the contents of the new version and the original version in order to identify common segments and simple patterns among contents of the two files. The knowledge of common segments and simple patterns is used to reduce/remove the differences among the versions required to be encoded in the delta file, thereby resulting in an overall performance gain.

The transmission of electronic file or software upgrades between a system and a client device can take a significant amount of time, especially when done via low bandwidth channels. An example is a cellular telephone software upgrade. It has become typical practice to send the byte-level file differences or changes between the new and original software versions over the cellular wireless couplings. The significant transfer time arises because the differences between the new and original versions of the executable files are more complex than the differences between their corresponding source files.

These complex differences between the new and original file versions arise in part because a small change in the source files often introduces major changes throughout the executable files. As an example, one type of change introduced in the executable files is a logical change that includes source code changes arising from source code line deletion from the original file, source code line addition to the new file, and source code line modifications. Logical changes occur, for example, when a programmer identifies a bug in a program and modifies the source file or code to eliminate the bug. The logical changes also include data initialization changes (e.g., the Internet Protocol (IP) address of a gateway server), resource and configuration file changes, and dictionary changes, but are not so limited.

Another type of introduced change is referred to herein as a secondary change. The secondary changes are defined to include, but not limited to, address changes, pointer target address changes, and changes in address offsets caused by address shifts resulting from the logical changes or code block swapping and generated by the software compiler/linker utilities. The pre-processing routines described below remove/reduce the secondary changes and encode information relating to the removal of these changes in information of the corresponding delta file.

Yet another type of introduced change includes byte-level code changes generated by the compiler/linker utilities not stemming from changes in the code logic or address shifts. For example, an instruction in the original version uses register R1, but the same instruction uses register R3 in the new version when, for example, register R1 is not available.

The optimizing routines described herein use relationships between the original and the new versions of files to reduce the amount of information encoded in the delta file as to differences relating to changes other than logical changes. With the minimum information, the effect of cascading computations can be achieved when doing byte-level differencing and reconstructing, thereby reducing the size of the delta file.

Returning to FIG. 2, the file differencing engine 106 receives the original version V1 and the new version V2 of a software image, along with the corresponding map files MV1 and MV2, respectively. The file differencing engine 106, as described above, is open and extensible and includes a differencing routine along with a layered structure of pre-optimizers and post-optimizers. The file differencing is performed by a core differencing routine or algorithm 210, where the file differencing includes but is not limited to byte-level file differencing. The layered structure of optimizers 202-206 and 222-226 is scalable and supports use of any number/type of optimizers as well as addition and deletion of optimizers, as appropriate, with little effect on the delta file.

Using a mathematical representation, any number/combination of pre-optimizers 202-206 generally modify the original version V1 to generate V1′ as
V1′=P(V1),
where the variable P represents pre-optimizing. In the absence of pre-optimizing, V1′=V1.

Following the pre-optimization, the differencing engine 106 calls the byte-level file differencing routines 210 to compute the differences between the modified original version V1′ and the new version V2. The differencing engine 106 then provides the output of the differencing routines 210 to any number/combination of post-optimizers 222-226, but is not so limited. The post-optimizers 222-226 generate an output δ′ as
δ′=V2−V1′,
where the variable δ′ represents the encoded differences between the modified original version V1′ and the new version V2.

Following post-optimizing, the differencing engine 106 generates the delta file δ230 which includes the encoded differences between the original version V1 and the new version V2. The difference engine 106, in generating the delta file, produces a delta file head and concatenates the file head with δ′ and Hint(P) as
δ=head+δ′+Hint(P),
where Hint(P) is the encoded information used by the pre-optimizers P. The encoded information used by the pre-optimizers 202-206 is transferred to the updating engine as Hint(P) for use by the updating engine in decoding information of the delta file.

The optimizers of an embodiment are generally classified as pre-optimizers and post-optimizers according to when they process information relative to the differencing operation, as described above, but are not so limited. These optimizers are optional, independent, and additive, as appropriate to the architecture and footprint of the system in which they are components. Therefore, some optimizers may be removed from the differencing engine when used in smaller computing systems, for example mobile electronic devices. Further, the optimizers are configurable before the file differencing engine is started. The optimizers take advantage of domain knowledge and are customized to improve the overall performance of the file differencing engine.

As an example of the configurability of the optimizers, assume the availability of n pre-optimizers 202-206 as P1, P2, . . . , Pn. A number k of the available n pre-optimizers are selected for inclusion in a differencing engine 106. Therefore, the pre-optimizing function of the differencing engine 106 is represented as
P=Pk° . . . P2°P1,
so that
P(V1)=Pk( . . . (P2(P1(V1))) . . . ).

The pre-optimizers 202-206, as described above, process information of the original version V1 and the new version V2 along with extracted information of the original version map file MV1 and the new version map file MV2. The pre-optimizers 202-206 modify the original software image in order to produce a modified software image, where the byte-level differences between the modified software image and the new software image are reduced. The pre-optimizers 202-206 take advantage of domain knowledge that includes knowledge of the processor on which the software images run and knowledge of the utilities that compile/link the software images. The pre-optimizers 202-206 of an embodiment use heuristic approaches based on patterns derived following pre-specified statistical rules. Some optimizers, for example, modify the original software image by removing/reducing the secondary changes resulting from address shifting, as describe in the Related Applications. Further, some optimizers rearrange the content sections of the original version in order to reduce the byte-level differences between the versions.

The post-optimizers 222-226 operate on the output of the differencing routines, but are not so limited. The post-optimizers 222-226 further reduce the size of the delta file using techniques including, but not limited to, data compression, identifying similar content, and encoding replacements in the original version image.

Following post-optimization, the differencing engine 106 outputs the delta file 230. The delta file 230 is generated in binary format, which includes a file head and a body. The file head includes pre-defined fields that indicate which optimizers were used to compute the file differences, along with the location and length of the minimum information used by the optimizer. The delta file body includes optimizer-related information and the encoded information of the primary changes.

Returning to FIG. 3, the file updating engine 116 receives the original version image V1 and the delta file 230, parses the delta file 230, and reconstructs a copy of the new version image V2, as described below. Using a mathematical representation, the updating engine receives the original version V1 of the software image along with the delta file δ230. The updating engine parses the delta file in order to locate the delta file head, δ′, and Hint(P), at block 302, where δ′ represents the encoded differences between the modified original version V1′ and the new version V2, and Hint(P) is the encoded information used by the pre-optimizers P. When information of the delta file head indicates pre-optimizing was performed by the differencing engine, the updating engine 116 identifies the optimizers used by the differencing engine, and locates and extracts the information used by the optimizers 202-206 and 222-226 from the delta file, at block 304. Operations of the updating engine 116 that correspond to the optimizers of the differencing engine 106 are then performed, at block 306.

For example, when information of the delta file head indicates pre-optimizing was performed by the differencing engine 106, the updating engine 116 applies Hint(P) to the original version V1 to generate V1′ as
V1′=P(V1),
where V1′ represents the modified original version. The updating engine 116 then calls the byte-level file updating routines to generate the new version V2 of the software image by applying δ′ to V1′ as
V2=V1′+δ′.
The updating engine then generates the new version V2 image.

As an example of a device and/or system using the differencing and updating engines described above, the computing devices receiving and using the delta file may be client devices that host corresponding software applications in need of updating, for example cellular telephones, mobile electronic devices, mobile communication devices, personal digital assistants, and other processor-based devices. This support is provided for all mobile device software ranging from firmware to embedded applications by enabling carriers and device manufacturers to efficiently distribute electronic file content and applications via their wireless infrastructure.

Another example of systems that benefit from the differencing and updating engines described above includes systems using wired serial connections to transfer the delta file from a device hosting the file differencing engine to a device hosting the file updating engine. These systems typically have slow transfer rates and, because the transfer rates are slow, a reduction in the size of the delta file is a way to realize faster transfer times.

Yet another example of systems that benefit from use of the differencing and updating engines includes wireless systems using radio communications to transfer the delta file from a device hosting the file differencing engine to a device hosting the file updating engine. While suffering from low reliability associated with the wireless connections, these systems also have slow transfer rates. The use of a smaller delta file in these systems provides several advantages. For example, the smaller file size results in a faster delta file transfer time. The faster transfer time, while saving time for the device user, reduces the opportunity for the introduction of errors into the delta file, thereby increasing system reliability. Also, with cellular communications, the reduced transfer time results in a cost savings for the consumer who is typically charged by the minute for service.

As another advantage, the smaller delta file reduces the bandwidth required to transfer the delta files to client devices. The reduced bandwidth allows for the support of more client devices via the allocated channels. As with the reduced transfer time, this too results in a reduction in operating costs for the wireless service provider.

Aspects of the invention may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the invention include: microcontrollers with memory (such as electronically erasable programmable read only memory (EEPROM)), embedded microprocessors, firmware, software, etc. Furthermore, aspects of the invention may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, shall refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize. The teachings of the invention provided herein can be applied to other processing systems and communication systems, not only for the file differencing and updating systems described above.

The elements and acts of the various embodiments described above can be combined to provide further embodiments. These and other changes can be made to the invention in light of the above detailed description.

All of the above references and United States patents and patent applications are incorporated herein by reference. Aspects of the invention can be modified, if necessary, to employ the systems, functions and concepts of the various patents and applications described above to provide yet further embodiments of the invention.

In general, in the following claims, the terms used should not be construed to limit the invention to the specific embodiments disclosed in the specification and the claims, but should be construed to include all processing systems that operate under the claims to provide file differencing. Accordingly, the invention is not limited by the disclosure, but instead the scope of the invention is to be determined entirely by the claims.

While certain aspects of the invention are presented below in certain claim forms, the inventors contemplate the various aspects of the invention in any number of claim forms. For example, while only one aspect of the invention is recited as embodied in computer-readable medium, other aspects may likewise be embodied in computer-readable medium. Accordingly, the inventors reserve the right to add additional claims after filing the application to pursue such additional claim forms for other aspects of the invention.

1. A system for updating electronic files of remote devices, comprising:
a first device including a file differencing engine that generates differences between an original version and a new version of an electronic file by:
identifying a first type of difference between the original and the new versions;
generating a modified version of the original version using information of the first type of difference;
generating encoded differences between the modified version and the new version, wherein the encoded differences include a second type of difference between the original and the new versions;
encoding the information of the first type of difference;
generating a difference file including the encoded differences and the encoded information of the first type of difference; and
a file updating engine hosted on the remote device, the file updating engine generating a copy of the new version using the difference file.

2. The system of claim 1, wherein generating a copy of the new version using the difference file further comprises:
receiving the difference file;
reading the encoded information of the first type of difference;
generating a modified version of the original file using the encoded information of the first type of difference; and
generating a copy of the new file using the modified version of the original file and the encoded differences between the modified version and the new file.

3. The system of claim 1, wherein the first type of difference includes at least one of differences resulting from address shifts due to source code line deletions, differences resulting from address shifts due to source code line additions, differences resulting from address shifts due to source code line modifications, differences resulting from address shifts due to code block swapping, and differences resulting from compiling/linking the new version.

4. The system of claim 1, wherein the second type of difference includes at least one of differences resulting from source code line deletions, differences resulting from source code line additions, differences resulting from source code line modifications, differences resulting from data initialization changes, differences resulting from resource file changes, differences resulting from configuration file changes, and differences resulting from dictionary changes.

5. The system of claim 1, wherein the remote device includes at least one of cellular telephones, portable communication devices, personal digital assistants, personal computers, and portable processor-based devices.

6. An apparatus for generating difference files, comprising:
means for identifying a first type of difference between an original file and a new file, wherein the new file includes an updated version of the original file;
means for generating a modified version of the original file using information of the first type of difference;
means for generating encoded differences between the modified version and the new file, wherein the encoded differences include a second type of difference between the original and the new files;
means for encoding the information of the first type of difference; and
means for generating a difference file including the encoded differences and the encoded information of the first type of difference.

7. The apparatus of claim 6, further comprising means for transferring the difference file to a remote system that hosts a copy of the original file, the remote system updating the hosted copy of the original file using the difference file.

8. A method for generating difference files, comprising:
receiving an original file and a new file, wherein the new file includes an updated version of the original file;
identifying a first type of difference between the original file and the new file;
generating a modified version of the original file using information of the first type of difference;
generating encoded differences between the modified version and the new file, wherein the encoded differences include a second type of difference;
encoding the information of the first type of difference; and
generating the difference file including the encoded differences and the encoded information of the first type of difference.

9. The method of claim 8, further comprising:
transferring the difference file to at least one remote system via at least one coupling, wherein the remote system includes at least one processor-based system, wherein the coupling includes at least one of a wireless coupling, a wired coupling, and a hybrid wireless/wired coupling; and
updating a hosted copy of the original file in the remote processing systems using the difference file.

10. A method for updating electronic files hosted on remote systems, comprising:
receiving an original file and a new file, wherein the new file includes an updated version of the original file;
identifying a first type of difference between the original file and the new file;
generating a modified version of the original file using information of the first type of difference;
generating encoded differences between the modified version and the new file, wherein the encoded differences include a second type of difference;
encoding the information of the first type of difference;
generating a difference file including the encoded differences and the encoded information of the first type of difference; and
updating a hosted copy of the original file in the remote systems using the difference file.

11. The method of claim 10, wherein updating further comprises:
receiving the difference file;
reading the encoded information of the first type of difference;
generating a modified version of the original file using the encoded information of the first type of difference; and
generating a copy of the new file using the modified version of the original file and the encoded differences between the modified version and the new file.

12. A computer readable medium including executable instructions which, when executed in a processing system, generate a difference file that includes coded differences between an original file and a new file by:
receiving the original and the new file, wherein the new file includes an updated version of the original file;
identifying a first type of difference between the original file and the new file;
generating a modified version of the original file using information of the first type of difference;
generating encoded differences between the modified version and the new file;
encoding the information of the first type of difference; and
generating a difference file including the encoded differences and the encoded information of the first type of difference.
